(19) United States
(12) Patent Application Publication
(10) Pub. No.: US 2007/0264982 A1
(43) Pub. Date: Nov. 15, 2007

(54) System and method for distributing media

(76) Inventors: John N. Nguyen, Arlington, MA (US); Venkatesh Mohanraj, Lowell, MA (US); Jeffrey D. Struven, Windham, NH (US); Eric C. Baur, Marlborough, MA (US); Toppie Baccam, Medford, MA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/414,749

(22) Filed: Apr. 28, 2006

(51) Int. Cl. H04Q 7/38; H04Q 7/22; H04M 3/42

(52) U.S. Cl. 455/414.1

(57) ABSTRACT

Information about a plurality of media files associated with a user of a mobile telephone is displayed, and in response to a user's selection, a media file of the plurality of media files is identified. A respective message from a group of messages that includes pre-defined messages is selected in response to an action by the user. A message is generated. The generated message includes the selected message, a recommendation for the identified media file and a link to a location that is specifically associated with the identified media file. The link is configured to provide access to the media file when activated. The message is transmitted to at least one recipient using a network.

### FIELD OF THE INVENTION

The present invention relates to distribution of digital media, and more specifically, to a system and method for recommending and retrieving digital media using networks.

### BACKGROUND

Exchanging and downloading of digital media, such as digital music files, games, images, videos and books, has become increasingly popular in recent years. The music industry, for example, now encourages and supports downloading of digital music over networks, such as the Internet. There are now numerous licensed sites that offer digital music. In 2004, there were over 140 million paid downloads in the U.S. These downloads generated $330 million in revenue for record companies. Such digital music sales are predicted to rise to 25% of the total revenue for record companies within five years.

The use of portable electronics has also increased significantly in recent years. Many consumers are now using portable devices, such as portable MP3 players, to play digital music. Portable devices that include communications capability, such as cellular or mobile telephones, may abet the existing market trends and offer consumers a platform for downloading and listening to music.

Unfortunately, existing channels for digital media offer consumers an overwhelming number of items for purchase. Consumers are often bewildered by such an excess number of choices. Existing approaches to providing recommendations to consumers may not track quickly changing interests and/or tastes, and may not correspond to small but pertinent peer groups. In addition, it is often difficult to provide recommendations to consumers using the small user interfaces that are available on existing portable devices. These challenges may act to reduce sales of digital media.

There is a need, therefore, for a system and method of distributing media that assists consumers in identifying digital media that the consumers may be interested in purchasing.

### SUMMARY OF EMBODIMENTS

A system and method for providing recommendations and retrieving content are described. In an embodiment of the method performed by a mobile telephone, information about a plurality of media files associated with a user of the mobile telephone is displayed, and in response to a user's selection, a media file of the plurality of media files is identified. A respective message from a group of messages that includes pre-defined messages is selected in response to an action by the user. A message is generated. The generated message includes the selected message, a recommendation for the identified media file and a link to a location that is specifically associated with the identified media file. The link is configured to provide access to the media file when activated. The message is transmitted to at least one recipient using a network.

The operations of displaying information, identifying a media file, selecting a respective message and/or generating the message may be performed by an application resident in the mobile telephone. In some embodiments, the operations of displaying information, identifying a media file, selecting a respective message and/or generating the message are performed by an integrated media player and recommendation application resident in the mobile telephone.

In another embodiment of the method, the media file is identified in response to a user's selection. The message is generated. The message includes the recommendation for the media file and the link to the location that is specifically associated with the media file. The link is configured to provide access to the media file when activated. The message is transmitted to at least the one recipient using the network.

When the message is generated, the respective message may be selected from the group of messages that includes pre-defined messages. In some embodiments, the message is added to the group of messages. In some embodiments, at least the one recipient for the message is selected using an address book. At least the one recipient for the message may be selected in accordance with a telephone number for at least the one recipient.

The message may be a text message. The message may be transmitted using Short Messaging Service (SMS), Multimedia Messaging Service (MMS), Wireless Application Protocol (WAP) Push, instant messaging and/or email. The network may include the Internet. The network may include wireless communication. The location may be a website and the link may be a URL.

In some embodiments, the message is received on a portable device. The portable device may include a music player and/or a cellular telephone. The media file may be provided by activating the link. The providing may include downloading at least a portion of the media file. At least the portion of the media file may be a preview of the media file.

In some embodiments, an additional file corresponding to the media file is downloaded. The additional file allows at least the portion of the media file to be played back using a software application that is compatible with the media file. In some embodiments, the software application is downloaded.

In some embodiments, the media file is purchased. A credit may be provided to a sender of the message when at least the one recipient purchases the media file. A confirmation message may be sent to a sender of the message when at least the one recipient purchases the media file. A list of top-N media files associated with the sender of the message may be provided to at least the one recipient.

The media file may be a digital music file. The message may include a description of the media file. The description may include an artist's name and a song title.

The method and system may reduce or eliminate the challenges associated with existing approaches to distributing media.

### BRIEF DESCRIPTION OF THE DRAWINGS

For a better understanding of the invention, reference should be made to the following detailed description taken in conjunction with the accompanying drawings, in which:

FIG. 1 is a block diagram illustrating an embodiment of a system for distributing media.

FIG. 2 is a flow diagram illustrating an embodiment of a method of providing a message that includes a recommendation.

FIG. 3 is a flow diagram illustrating an embodiment of a method of receiving a message that includes a recommendation.

FIG. 4 is a block diagram illustrating an embodiment of a mobile device.

FIG. 5 is a block diagram illustrating an embodiment of an application server.

FIG. 6A is a block diagram illustrating an embodiment of a user interface.

FIG. 6B is a block diagram illustrating an embodiment of a user interface.

FIG. 6C is a block diagram illustrating an embodiment of a user interface.

FIG. 6D is a block diagram illustrating an embodiment of a user interface.

FIG. 6E is a block diagram illustrating an embodiment of a user interface.

FIG. 7A is a block diagram illustrating an embodiment of a user interface.

FIG. 7B is a block diagram illustrating an embodiment of a user interface.

FIG. 8 is a block diagram illustrating an embodiment of a message data structure.

FIG. 9 is a block diagram illustrating an embodiment of an address book data structure.

FIG. 10 is a block diagram illustrating an embodiment of a music data structure.

Like reference numerals refer to corresponding parts throughout the drawings.

### DETAILED DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments.

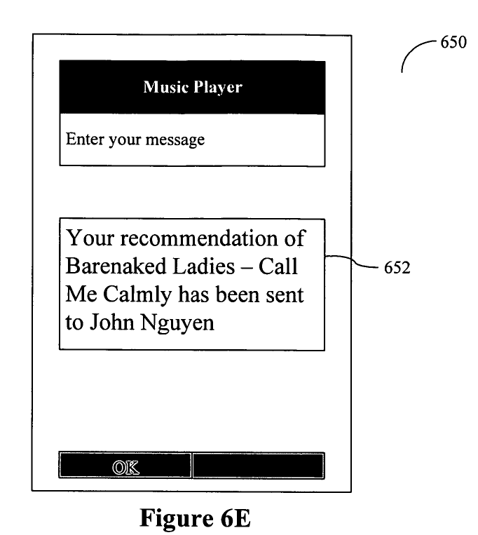

A system and method for distributing media are described. Individuals may use the system and/or practice the method to provide one or more recommendations to one or more recipients, such as friends and/or colleagues, who in turn may act on the recommendations. The recommendations may be one or more messages that include one or more links, such as a uniform resource locator (URL) or hyperlink to a web page or website, that is specifically associated with one or more media files, such as one or more music tracks. A sender of a message may select the message from a pre-defined list or group of messages, as described below in the discussion of FIG. 8. The sender may select one or more recipients from an address book, for example, based on one or more telephone numbers for the one or more recipients.

By accessing the link (for example, by clicking on it), a respective recipient of the message may access a respective media file. This may include downloading at least a portion of the respective media file, such as a preview of the respective media file and/or the respective media file. The recipient may download an application program that is compatible with the respective media file and that allows the recipient to play the respective media file back. The respective recipient may download a header file, such as a Digital Rights Management file or header, that unlocks the respective media file and allows the respective recipient to play the respective media file. The respective recipient may purchase the respective media file.

In some embodiments, the sender of the message may be notified when at least one recipient purchases the respective media file. The sender may receive a credit, such as a financial reward and/or a financial discount, after sending the message and/or when at least one recipient purchases the respective media file. The financial reward and/or the financial reward may be used, by the sender, during a future purchase of another media file. In some embodiments, the sender may pay for a respective media file sent to one or more recipients. For example, the sender may send the respective media file as a gift.

The respective media file may include digital music, a game, an image, a video, a ring tone, software and/or a book or printed document. In an exemplary embodiment, the messages, which include the recommendations and associated links, may be communicated between portable or mobile devices, such as cellular telephones, personal digital assistants, portable music players, notebook computers and/or tablet computers. The messages may be communicated, at least in part, using computers and/or servers. The messages may be communicated using email, Short Message Service (SMS), text messaging, instant messaging, Multimedia Message Service (MMS) and/or a Wireless Application protocol (WAP). The messages may be communicated over a network, such as the World Wide Web (WWW) or the Internet, an Intranet, a local area network that uses a protocol such as Bluetooth and/or WiFi, a wired network, a network with a persistent connection and/or a wireless network. The wireless network may use one or more communications protocols, including Global System for Mobile communications (GSM), Code Division Multiple Access (CDMA) and/or Time Division Multiple Access (TDMA).

By providing messages that allow senders and recipients to exchange recommendations, to preview media files and/or to purchase media files, the system and method may make it easier to determine relevant content, i.e., content that is of interest. The system and method may, therefore, increase sales of such media files. In addition, the system and method may be implemented using existing user interfaces on portable devices, thereby further increasing the ease of use and effectiveness of using such portable devices to purchase and/or play back the media files.

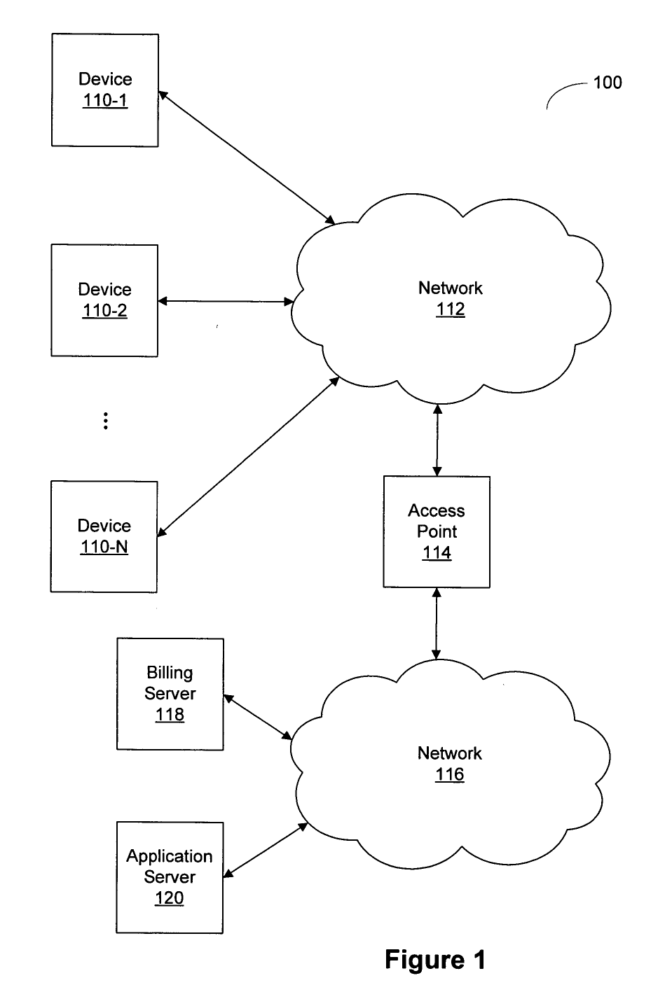

Attention is now directed towards a system for distributing media. FIG. 1 is a block diagram illustrating an embodiment of a system 100 for distributing media. In the system 100, one or more portable devices 110 communicate using a network 112. In an exemplary embodiment, the one or more portable devices are cellular telephones and the network 112 is a cellular telephone network.

An access point 114 may couple the network 112 to a network 116. In an exemplary embodiment, the network 116 is the Internet. The network 116 is coupled to a billing server 118 and an application server 120. The access point 114 may be configured to act as a gate keeper, allowing a subset of the devices 110 to communicate with the billing server 118 and the application server 120. The subset of the devices 110 may correspond to those users that have signed up for and/or paid for the messaging and media file distribution system that is described below. In some embodiments, the subset of the devices 110 may correspond to those users that receive service from a respective service provider. The service may be cellular telephone service and/or Internet service.

The billing server 118 may keep track of financial transactions in the media file distribution system, including credits (e.g., credits for recommendations provided and/or recommendations that are acted on by one or more recipients) and debits (e.g., debits corresponding to user purchases of media files). The applications server 120 may store and provide the media files, such as music files and/or previews of the music files, to one or more of the mobile devices 110. In some embodiments, the applications server 120 may store and/or provide one or more messages (including the recommendations and the links) to one or more of the devices 110 in response to a user's instructions instead of generating and transmitting the one or more messages from the user's device, such as device 110-1. The applications server 120 may store and provide one or more applications programs that are compatible with the media files and that allow recipients of the media files to play the media files back. The one or more applications programs may be configured to execute on one or more of the portable devices 110. The applications server 120 may store and provide Digital Rights Management headers corresponding to the media files.

In some embodiments, the system 100 may include additional or fewer components. Functions or one or more of the components may be implemented by another component. Two or more components may be combined into a single component. Positions of one or more components may be changed.

Attention is now directed towards embodiments of methods or processes for distributing media. A user of a portable device may choose to send a message to recommend a media file to one or more recipients. For example, after downloading and/or purchasing a digital music file, the user may wish to recommend it to one or more friends and/or colleagues. Alternatively, the user may wish to recommend one or more music files in a collection of music files that he or she has already downloaded and/or purchased. This user may generate the message using a recommendation application that is resident in the portable device and/or the applications server 120 (FIG. 1).

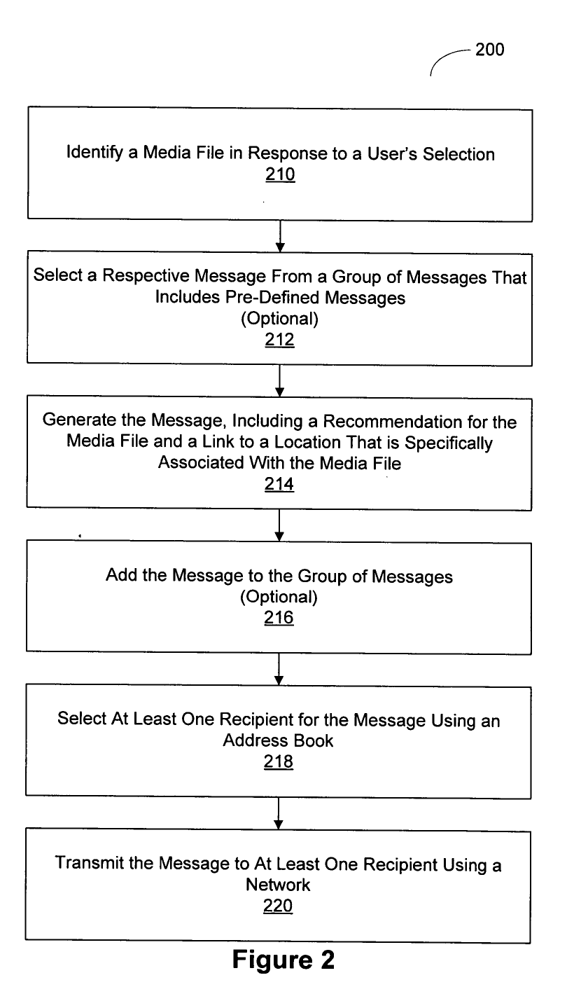

FIG. 2 is a flow diagram illustrating an embodiment of a method 200 of providing a message that includes a recommendation. A media file is identified in response to a user's selection (210). A respective message is optionally selected from a group of messages that includes pre-defined messages (212). In some embodiments, the user may create at least a portion of a message. The message, including a recommendation for the media file and a link to a location that is specifically associated with the media file, is generated (214). The message is optionally added to the group of messages (216). At least one recipient for the message is selected using an address book (218). In other embodiments, at least one recipient may be selected by entering one or more telephone numbers. The message is transmitted to at least one recipient using a network (220).

In an illustrative example, Mary Smith, who has previously purchased music files corresponding to songs by several groups, including Kosheen, and downloaded them, wants to recommend Kosheen's song “Hungry” to her friend John Smithson. In other embodiments, however, Mary Smith may additionally recommend music files that she has not purchased, for example, by selecting music files listed on a website for a store. On her cellular telephone, she selects “Kosheen—Hungry” from a folder that includes her music files. Optionally, at this point Mary may listen to all or a portion of the selected music file. She may do this, for instance, to verify that she has in fact selected the song that she intends to recommend to John. Continuing with our example, Mary selects an option to recommend that song. When Mary is prompted for the recipient, she scans through her address book using a music player and/or recommendation application and selects John Smithson. Mary may search for the recipient based on the recipient's telephone number.

Mary may select content for her message from a list of pre-defined messages. For example, she may select “Take a look at this song.” In some embodiments, Mary may type in the content of the message that includes the recommendation. In some embodiments, the recommendation is appended to Mary's message by the music player and/or recommendation application. A new message created by Mary may be added to the list of pre-defined messages. The music player and/or recommendation application may generate the message for John Smithson, including the selected content (the recommendation) as well as the associated link. The message may include a description of the media file. For music files, the message may include a song title, artist's name and/or identification number.

The cellular telephone may transmit the message to John Smithson, for example, when Mary presses a “Send” key or icon. In an exemplary embodiment, the message is a text message. The message may be communicated using SMS. A confirmation message may be displayed on Mary's cellular telephone when the message is sent. If John Smithson purchases the song, another confirmation message may be sent to and displayed on Mary's cellular telephone. As discussed previously, Mary may receive a financial incentive and/or a financial discount for sending the recommendation and/or if John Smithson purchases the song.

The method 200 may include fewer operations or additional operations. Two or more of the aforementioned operations may be combined. A position of one or more of the operations may be changed.

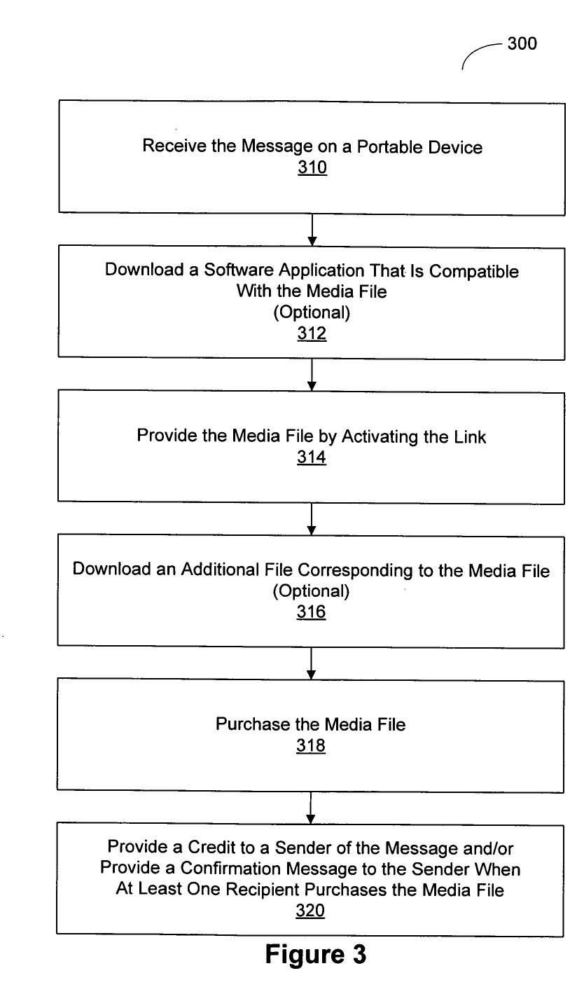

FIG. 3 is a flow diagram illustrating an embodiment of a method 300 of receiving a message that includes a recommendation. The message is received on a portable device (310). A software application that is compatible with the media file is optionally downloaded (312). Alternately, if the application is already resident on the receiving portable device the application is not downloaded during the operation of method 300. The media file is provided by activating the link (314). An additional file corresponding to the media file, such as a Digital Rights Management file, is optionally downloaded (316). The media file is purchased (318). In some embodiments, a credit is provided to a sender of the message and/or a confirmation message is provided to the sender when at least one recipient purchases the media file (320).

In an illustrative example, John Smithson receives Mary's message on his cellular telephone. The message indicates that he should “Take a look at this song. Kosheen—Hungry” and includes a link, such as a URL, that he can click on. If John has not previously downloaded compatible music player application or software, when he clicks on the link he may be prompted to download the appropriate software (for example, from the application server 120 in FIG. 1). In some embodiments, the music player application may be automatically downloaded when he clicks on the link. Once the music player application resides in John's cellular telephone, when he clicks on the link, he is shown a menu that allows him to preview a portion of the song and/or purchase the full song recommended by Mary. If John purchases the recommended song, the transaction is logged by the billing server 118 (FIG. 1) for subsequent processing (such as billing John). In some embodiments, after a recipient, such as John, has purchased a recommended song or declines to purchase it, he or she may be allowed to view a list of the sender's favorite songs, for example, the top-10 songs. In some embodiments, recommendation recipients are allowed to view a list of the sender's favorite songs only if the sender as explicitly enabled that capability or has otherwise consented to the sharing of that information.

The method 300 may include fewer operations or additional operations. For example, in some embodiments operations 314 and 316 are combined, i.e., Digital Rights Management information is included in the media file. Two or more of the aforementioned operations may be combined. A position of one or more of the operations may be changed.

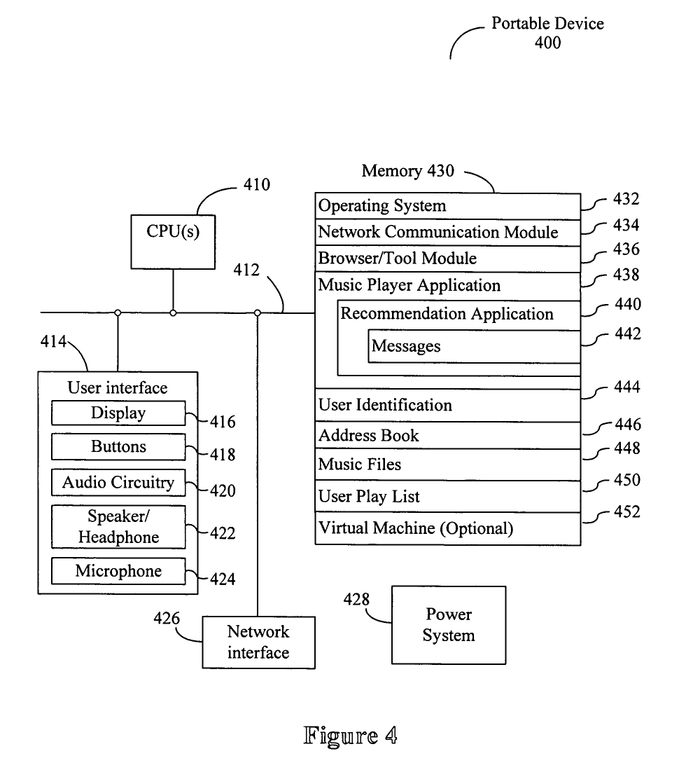

Attention is now directed towards embodiments of devices in the media distribution system. FIG. 4 is a block diagram illustrating an embodiment of a portable device 400, such as one of the portable devices 110 (FIG. 1). The portable device 400 may include one or more processing units (CPU's) 410, a user interface 414, one or more network or other communications interfaces 426, a power management system 428 (including a power management module and a power source, such as a battery), memory 430, and one or more signal lines and/or communication buses 412 for coupling these components. The user interface 414 may have one or more displays 416 for viewing text and images, one or more buttons 418 (such as a keyboard) for entering text and making selections, audio circuitry 420 for processing verbal information, one or more speakers/headphones 422 and/or a microphone 424. Memory 430 may include random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The communication buses 412 may include circuitry (sometimes called a chipset) that interconnects and controls communications between system components. The network interface 426 may be coupled to a network, such as the Internet, other wide area networks, local area networks and/or metropolitan area networks.

In some embodiments, memory 430 stores programs, modules and/or data structures, including
an embedded operating system 432, such as LINUX, UNIX, Symbian or WINDOWS, that includes procedures (or sets of instructions) for handling various basic system services and for performing hardware dependent tasks,
a network communication module 434 (or a set of instructions) that is used for communicating messages (such as SMS messages) between the portable device 400 and other portable devices and/or servers (such as the applications server 120 in FIG. 1) using the one or more network interfaces 426,
a browser/tool module 436 (or a set of instructions) for accessing and viewing web pages and other documents stored on hosts on the Internet or an intranet,
a music player application 438 (or a set of instructions), user identification 444 (which may be used by the billing server 118 and/or the applications server 120 in FIG. 1 to track and/or log transactions),
an address book 446 including names and telephone numbers for individuals and/or groups of individuals,
one or more music files 448, and/or
a user play list 450 including at least some of the songs that the user has listened to.

The music player application 438 may include a recommendation application 440. The recommendation application 440 may include one or more pre-defined messages 442. The music player application 438 may be for playing back one or more of the downloaded music files 448. The recommendation application 440 may allow a user to select one or the pre-defined messages 442, to edit one of the pre-defined messages 442 or enter a new message. The recommendation application 440 may generate the message including the recommendation and the link to a music file, such as one of the music files 448, as described previously in the embodiment 200 (FIG. 2). In some embodiments, the music player application 438 and/or the recommendation application 440 are written in a programming language that is independent of the operating system 432, such as Java. Applications written in such a programming language may be executed, at least in part, using an optional Java virtual machine or other virtual machine 452.

In some embodiments, the application 438 is a multimedia player application for playing video files, music files and possibly other types of multimedia files.

Each of the above identified modules and applications corresponds to a set of instructions for performing one or more functions described above. These modules (i.e., sets of instructions) need not be implemented as separate software programs, procedures or modules. The various modules and sub-modules may be rearranged and/or combined. Memory 430 may include additional modules and/or sub-modules, or fewer modules and/or sub-modules. For example, while the recommendation application 440 and the music player application 438 are integrated in the portable device 400, in other embodiments, the recommendation application 440 and the music player application 438 may be separate applications. In some embodiments, some or all of the functionality of the recommendation application 440 may be implemented on the application server 120 (FIG. 1). Memory 430, therefore, may include a subset or a superset of the above identified modules and/or sub-modules.

The portable device 400 may include additional components or fewer components. Two or more components may be combined into a single component. Positions of one or more components may be changed.

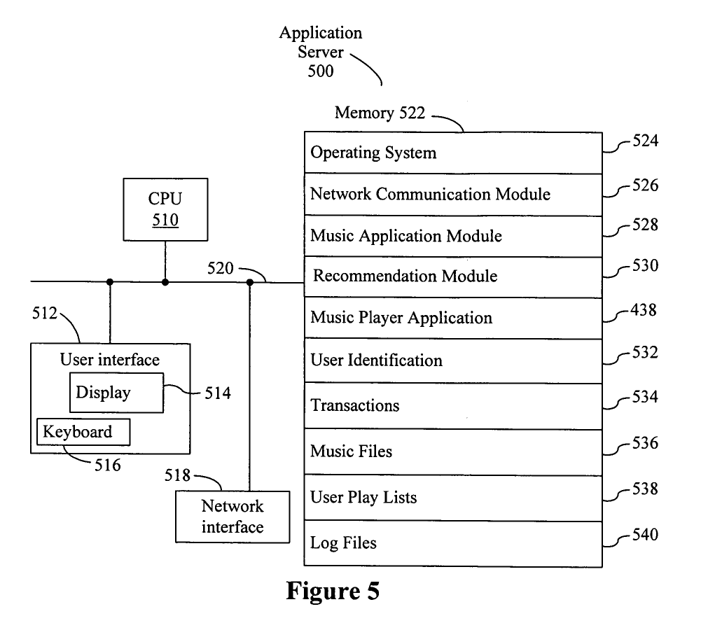

FIG. 5 is a block diagram illustrating an embodiment of an application server 500, such as the application server 120 (FIG. 1). The application server 500 may include one or more processing units (CPU's) 510, a user interface 512, one or more network or other communications interfaces 518, memory 522, and one or more signal lines and/or communication buses 520 for coupling these components. The user interface 512 may have one or more displays 514 for viewing text and images and/or a keyboard 516 for entering text and making selections. Memory 522 may include random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. At least a portion of the memory 522 may be stored on a mass storage device that is remotely located from the one or more processors 510. The communication buses 520 may include circuitry (sometimes called a chipset) that interconnects and controls communications between system components. The network interface 518 may be coupled to a network, such as the Internet, other wide area networks, local area networks and/or metropolitan area networks.

In some embodiments, memory 522 stores programs, modules and/or data structures, including
an operating system 524, such as LINUX, UNIX or WINDOWS, that includes procedures (or sets of instructions) for handling various basic system services and for performing hardware dependent tasks,
a network communication module 526 (or a set of instructions) that is used for communicating messages (such as SMS messages) between the applications server 500 and portable devices (such as the portable devices 110 in FIG. 1) using the one or more network interfaces 518,
a music applications module 528 (or a set of instructions) for providing the device-based music application 438 in portable device 400 (FIG. 4) with music files and logic for navigating the music store,
a recommendation module 530 (or a set of instructions) for processing messages that include user recommendations and links from the one or more portable devices, the music player application 438 (or a set of instructions) that may be downloaded by users of one or more of the portable devices,
user identification 532 (such as subscriber identification numbers) for transaction tracking and logging,
transactions 534 (such as music files purchased by different users, as well as financial credits and/or financial discounts),
music files 536 that may be downloaded and/or purchased, play lists 538 for one or more of the users, and/or
log files 540 of transactions that have occurred.

The log files 540 may include a relational database that stores one content record for each music file or song and/or one transaction record for each user preview or purchase transaction. A content record may include a track identification number, a title, an artist, a playing length, as well as other descriptors. A transaction record may include the user's identification number 532, a music file identification number, whether the music file was previewed or purchased, start and finish times of a download, and/or a price billed to the user.

In some embodiments, the application module 528 is a multimedia application for handling video files, music files and possibly other types of multimedia files.

Each of the above identified modules and applications corresponds to a set of instructions for performing one or more functions described above. These modules (i.e., sets of instructions) need not be implemented as separate software programs, procedures or modules. The various modules and sub-modules may be rearranged and/or combined. Memory 522 may include additional modules and/or sub-modules, or fewer modules and/or sub-modules. Memory 522, therefore, may include a subset or a superset of the above identified modules and/or sub-modules.

The application server 500 may include additional components or fewer components. Two or more components may be combined into a single component. Positions of one or more components may be changed.

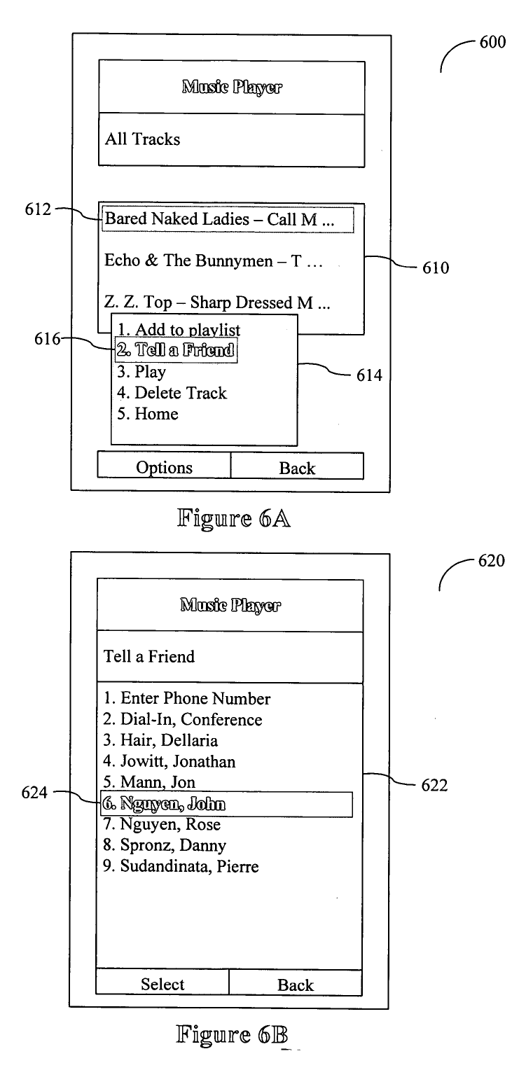

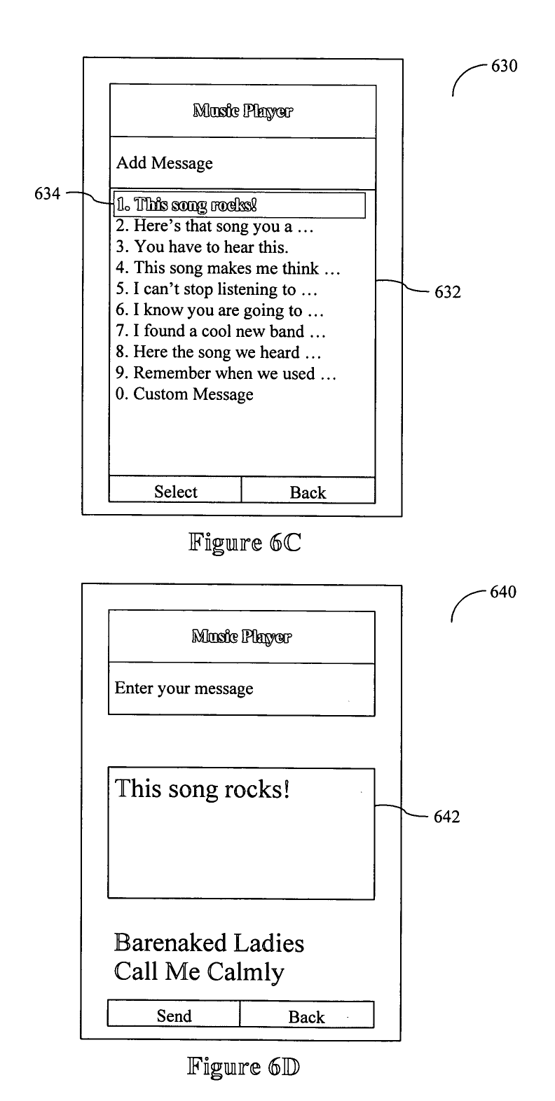

Attention is now directed towards embodiments of user interfaces in the media distribution system. FIGS. 6A-6E and 7A-7B are block diagrams, or schematic screen shots, showing one illustrative embodiment of many possible embodiments of such user interfaces.

FIG. 6A is a block diagram illustrating an embodiment of a user interface 600. The user interface 600 corresponds to the music player application 438 (FIG. 4). In the user interface 600, a set of music files or songs 610 is displayed. When one of the songs 610, such as the song 612, is selected, a set of command options 614 are displayed. One of the command options is Tell a Friend 616, which corresponds to the recommendation application 440 (FIG. 4).

FIG. 6B is a block diagram illustrating an embodiment of a user interface 620 that includes additional command options 622 that are displayed when the Tell a Friend 616 (FIG. 6A) command is selected. The music player application 438 (FIG. 4) may load at least some data from the address book 446 (FIG. 4) and display this data in the user interface 620. The data may include one or more individuals. The user may select one of these individuals, such as John Nguyen 624. Alternatively, the user may enter a phone number associated with one or more of the individuals to whom he or she would like to send a recommendation message.

The music player application 438 (FIG. 4) may display a list of stored or pre-defined recommendation messages 442 (FIG. 4). This is illustrated in FIG. 6C, which is a block diagram illustrating an embodiment of a user interface 630. The user may select a pre-defined message 634 from a displayed list of pre-defined messages 632. Alternatively, the user may type in a new message.

The selected or entered message may be edited by the user. This is illustrated in FIG. 6D, which is a block diagram illustrating an embodiment of a user interface 640. The selected or entered message may be displayed in an editing window 642 for this purpose. While not shown, the music player application 438 (FIG. 4) may also embed a link to the selected song 612 (FIG. 6A) in the selected or entered message. In addition, a description of the selected song 612 (FIG. 6A) may be included in the selected or entered message.

When the message is completed and the user presses “Send,” the message may be transmitted. As shown in FIG. 6E, which is a block diagram illustrating an embodiment of a user interface 650, a confirmation message 652 may be displayed.

The message may be viewed by one or more recipients. This is illustrated in FIG. 7A, which is a block diagram illustrating an embodiment of a user interface 700. The message includes a recommendation 710 and a link 712 associated with the song 612 (FIG. 6A). The recommendation 710 may include the artist and the song title.

When the recipient clicks on the link 712, the music player application 438 (FIG. 4) is launched. This is illustrated in FIG. 7B, which is a block diagram illustrating an embodiment of a user interface 720. A list of command options is displayed 722. The user may select one of the command options, such as a Preview command 724.

Attention is now directed towards embodiments of data structures that may be used to implement the system and/or method described previously. FIG. 8 is a block diagram illustrating an embodiment 800 of a message data structure 810. The message data structure 810 may include a plurality of pre-defined messages 812. A respective message, such as message 812-1, may include corresponding recommendation text 814.

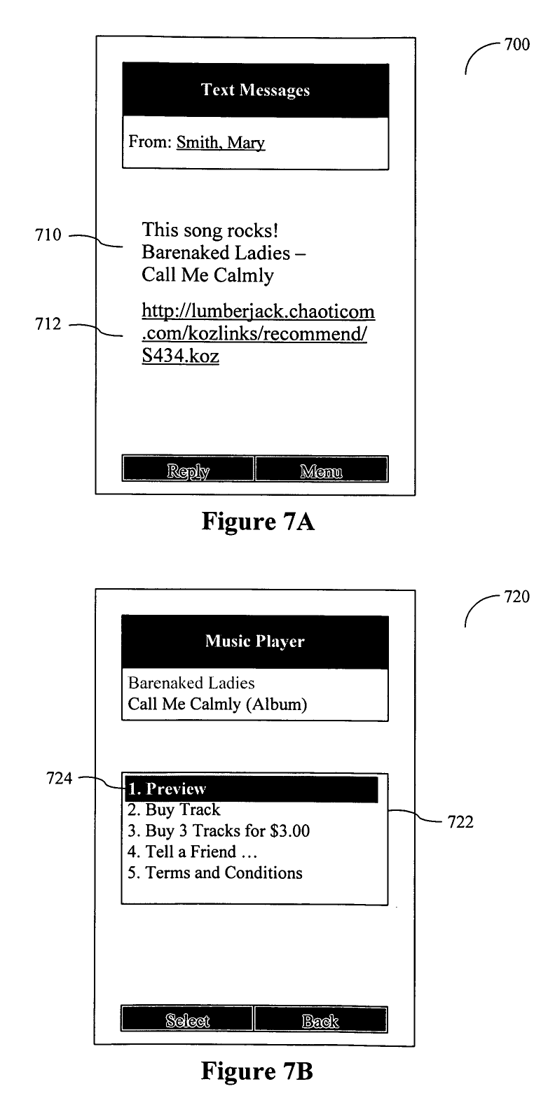

FIG. 9 is a block diagram illustrating an embodiment 900 of an address book data structure 910. The address book data structure 910 includes a plurality of entries 912 corresponding to individuals or groups of individuals. A respective entry, such as entry 912-1, may include one or more names 914, one or more telephone numbers 918 and/or one or more email addresses 920. A respective entry may optionally include one or more addresses 916. Some entries may include a name and telephone number without an email address, while other entries may include a name and email address without a telephone number. Some entries may include two or more telephone numbers and/or two or more email addresses.

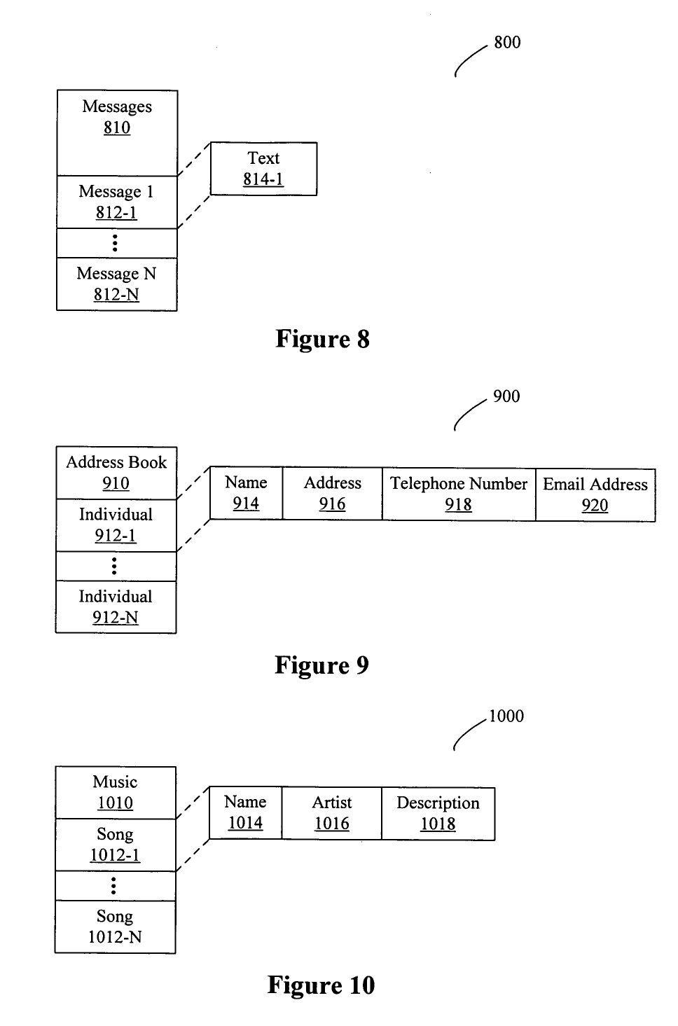

FIG. 10 is a block diagram illustrating an embodiment 1000 of a music data structure 1010. The music data structure 1010 may include a plurality of music files or songs 1012. A respective song, such as a song 1012-1, may include a song title or name 1014, an artist name 1016 and/or a description 1018 of the song 1012-1. The music files or songs 1012 may be stored in one or more formats, such as AAC+ or MP3. The descriptions 1018 may be embedded in ID3 tags in the music files 1012. The music file 1012 may also include an identification number, such as an International Standard Recording Code (ISRC), and/or one provided by a universal-music-ID provider such as All Music Guide (AMG) or GraceNote.

While the embodiments describe communication of messages, such as SMS text messages, from one portable device to another, in other embodiments, the recommendations may be pushed to users from the application server 120 (FIG. 1) using technology such as WAP-Push. For example, a user may receive recommendations in accordance with one or more media files 448 (FIG. 4) that the user has download. In some embodiments, a user may receive recommendations in accordance with one or more media files 448 (FIG. 4) in the user play list 450 (FIG. 4).

The foregoing descriptions of specific embodiments of the present invention are presented for purposes of illustration and description. They are not intended to be exhaustive or to limit the invention to the precise forms disclosed. Rather, it should be appreciated that many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method performed by a mobile telephone, the method comprising:
at the mobile telephone:
displaying information about a plurality of media files associated with a user of the mobile telephone, and in response to a user's selection, identifying a media file of the plurality of media files;
in response to an action by the user, selecting a respective message from a group of messages that includes pre-defined messages;
generating a message, the generated message including the selected message, a recommendation for the identified media file and a link to a location that is specifically associated with the identified media file; wherein the link is configured to provide access to the media file when activated; and
transmitting the message to at least one recipient using a network.

2. The method of claim 1, wherein the operations of displaying information, identifying a media file, selecting a respective message and generating the message are performed by an application resident in the mobile telephone.

3. The method of claim 1, wherein the operations of displaying information, identifying a media file, selecting a respective message and generating the message are performed by an integrated media player and recommendation application resident in the mobile telephone.

4. A method, comprising:
identifying a media file in response to a user's selection;
generating a message, wherein the message includes a recommendation for the media file and a link to a location that is specifically associated with the media file, and wherein the link is configured to provide access to the media file when activated; and
transmitting the message to at least one recipient using a network.

5. The method of claim 4, wherein the generating includes selecting a respective message from a group of messages that includes pre-defined messages.

6. The method of claim 4, further comprising adding the message to a group of messages.

7. The method of claim 4, further comprising selecting at least the one recipient for the message using an address book.

8. The method of claim 4, further comprising selecting at least the one recipient for the message in accordance with a telephone number for at least the one recipient.

9. The method of claim 4, wherein the message is a text message.

10. The method of claim 4, wherein the message is transmitted using a technique selected from the group consisting of SMS, MMS, WAP, instant messaging and email.

11. The method of claim 4, wherein the network includes the Internet.

12. The method of claim 4, wherein the network includes wireless communication.

13. The method of claim 4, wherein the location is a website and the link is a URL.

14. The method of claim 4, further comprising receiving the message on a portable device.

15. The method of claim 14, wherein the portable device includes a music player.

16. The method of claim 15, wherein the portable device includes a cellular telephone.

17. The method of claim 14, further comprising providing the media file by activating the link, wherein the providing includes downloading at least a portion of the media file.

18. The method of claim 17, wherein at least the portion of the media file is a preview of the media file.

19. The method of claim 17, further comprising downloading an additional file corresponding to the media file, wherein the additional file allow at least the portion of the media file to be played back using a software application that is compatible with the media file.

20. The method of claim 17, further comprising downloading a software application that is compatible with the media file, wherein the software application is configured to play back the media file.

21. The method of claim 17, further comprising purchasing the media file.

22. The method of claim 21, further comprising providing a credit to a sender of the message when at least the one recipient purchases the media file.

23. The method of claim 21, further comprising sending a confirmation message to a sender of the message when at least the one recipient purchases the media file.

24. The method of claim 17, further comprising providing a list of top-N media files associated with a sender of the message to at least the one recipient.

25. The method of claim 4, wherein the media file includes a digital music file.

26. The method of claim 4, wherein the message includes a description of the media file.

27. The method of claim 26, wherein the description includes an artist's name and a song title.

28. An apparatus, comprising:
a memory;
a processor; and
a program, wherein the program is stored in the main memory and executed by the processor, the program including:
instructions for identifying a media file in response to a user's selection;
instructions for generating a message, wherein the message includes a recommendation for the media file and a link to a location that is specifically associated with the media file, and wherein the link is configured to provide access to the media file when activated; and
instructions for transmitting the message to at least one recipient using a network.

29. An apparatus, comprising:
a memory;
a processor; and
a program, wherein the program is stored in the main memory and executed by the processor, the program including:
instructions for receiving a message on a portable device, wherein the message is to be provided by a sender, the messages includes a recommendation for a media file and a link to a location that is specifically associated with the media file;
instructions for providing the media file by activating the link, wherein the providing includes downloading at least a portion of the media file; and
instructions for purchasing the media file.

30. An apparatus, comprising:
a first means;
a second means for executing a program mechanism stored in the first means; and
the program mechanism, the program mechanism including:
instructions for identifying a media file in response to a user's selection;
instructions for generating a message, wherein the message includes a recommendation for the media file and a link to a location that is specifically associated with the media file, and wherein the link is configured to provide access to the media file when activated; and
instructions for transmitting the message to at least one recipient using a network.
